(19) United States
(12) Patent Application Publication
(10) Pub. No.: US 2005/0150162 A1
(43) Pub. Date: Jul. 14, 2005

(54) Flower preservation device

(76) Inventor: Boris Usherovich, Staten Island, NY (US)

Correspondence Address: Christopher G. Trainor, Esq.;Carter, DeLuca, Farrell & Schmidt, LLP, Suite 225, 445 Broad Hollow Road, Melville, NY, 11747, US

(21) Appl. No.: 10/755,792

(22) Filed: Jan. 12, 2004

(51) Int. Cl. A47G 7/06; A01G 9/02

(52) U.S. Cl. 47/66.6; 47/41.01

(57) ABSTRACT

A cooling device is configured to cool fluid, e.g., water, contained within a vessel, e.g., a vase. The cooling device may be formed integrally with the vessel or separately therefrom. Preferably, the cooling device includes an electrically powered thermal electric cooler.

### BACKGROUND

1. Technical Field

The present disclosure relates generally to a vessel for holding and displaying cut flowers. More specifically, the present disclosure relates to a vessel for holding and displaying cut flowers have a cooling mechanism associated there with for prolonging the life of the cut flowers.

2. Background of Related Art

Vessels for holding and displaying cut flowers, i.e., vases, are well known. Typically, vases define an open reservoir for holding a quantity of water and receiving the stems of cut flowers. The vase may be constructed from a variety of different materials including plastics, metals, glass, porcelain, etc. and may assume an infinite number of configurations. The reservoir defined by the vase is of a depth sufficient to allow a stem of a cut flower to be partly immersed in the water held within the reservoir.

Flowers can be very expensive yet have a short lifespan. As such, many people who appreciate the beauty and aroma of flowers purchase flowers only on special occasions. Techniques have been developed to extend the life of cut flowers. These techniques include providing addititives, e.g., foods, preservatives, etc., to the water in the vase, changing the vase water regularly, and cutting the flower stems beneath the surface of the water. Typically, these techniques are time consuming and have a limited effect on the life span of the cut flowers in the vase. Florists extend the life of cut flowers by keeping the cut flowers in a temperature controlled cooler since the lifespan of flowers is greater at cooler temperatures than at room temperature. However, excessively cold temperatures might freeze tender blooms. Thus, storing cut flowers in a home refrigerator may not be the best idea. In addition, fruits and vegetables stored in refrigerators can give off ethylene gas that will cause the flowers to age prematurely.

Accordingly, a continuing need exists in the art for a method and/or device for extending the life of cut flowers in the home.

### SUMMARY

A cooling device is provided which is configured to cool fluid, e.g., water, contained within a vessel, e.g., a vase. The cooling device may be formed integrally with the vessel or separately therefrom. Preferably, the cooling device includes an electrically powered, e.g., battery, AC, DC, etc. thermal electric cooler. In one preferred embodiment, the vessel and the cooling device are integrally formed such as by molding. In another preferred embodiment, the cooling device defines a receptacle for releasably receiving a plurality of different vessels. In yet another preferred embodiment, the cooling device is supported within a wrap around sleeve which includes adjustable fastening structure to facilitate attachment of the cooling device to vessels of different sizes and configurations.

### BRIEF DESCRIPTION OF THE DRAWINGS

Preferred embodiments of the present disclosure are described herein with reference to the drawings wherein:

FIG. 1 is a side perspective view of one preferred embodiment of the presently disclosed vase and cooling device;

FIG. 2 is a side perspective view of another preferred embodiment of the presently disclosed vase and cooling device;

FIG. 3 is a side perspective view of another preferred embodiment of the presently disclosed vase and cooling device;

FIG. 4 is a side perspective view of yet another preferred embodiment of the presently disclosed vase and cooling device;

FIG. 5 is a side perspective view of another preferred embodiment of the presently disclosed vase and cooling device with parts separated;

FIG. 5A is a side perspective view of another preferred embodiment of the presently disclosed cooling device;

FIG. 6 is a side perspective view of another preferred embodiment of the presently disclosed vase and cooling device;

FIG. 7 is a side perspective view of yet another preferred embodiment of the presently disclosed vase and cooling device with parts separated;

FIG. 8 is a side cross-sectional view of the vase and cooling device shown in FIG. 7 with the cooling device secured to the vase;

FIG. 9 is a side partial cross-sectional view of another preferred embodiment of the presently disclosed cooling device.

FIG. 10 is a side perspective view of another preferred embodiment of the presently disclosed cooling device having a vase positioned therein.

### DETAILED DESCRIPTION OF PREFERRED EMBODIMENTS

Preferred embodiments of the presently disclosed vase and associated cooling device will now be described in detail with reference to the drawings, in which like reference numerals designate identical or corresponding elements in each of the several views.

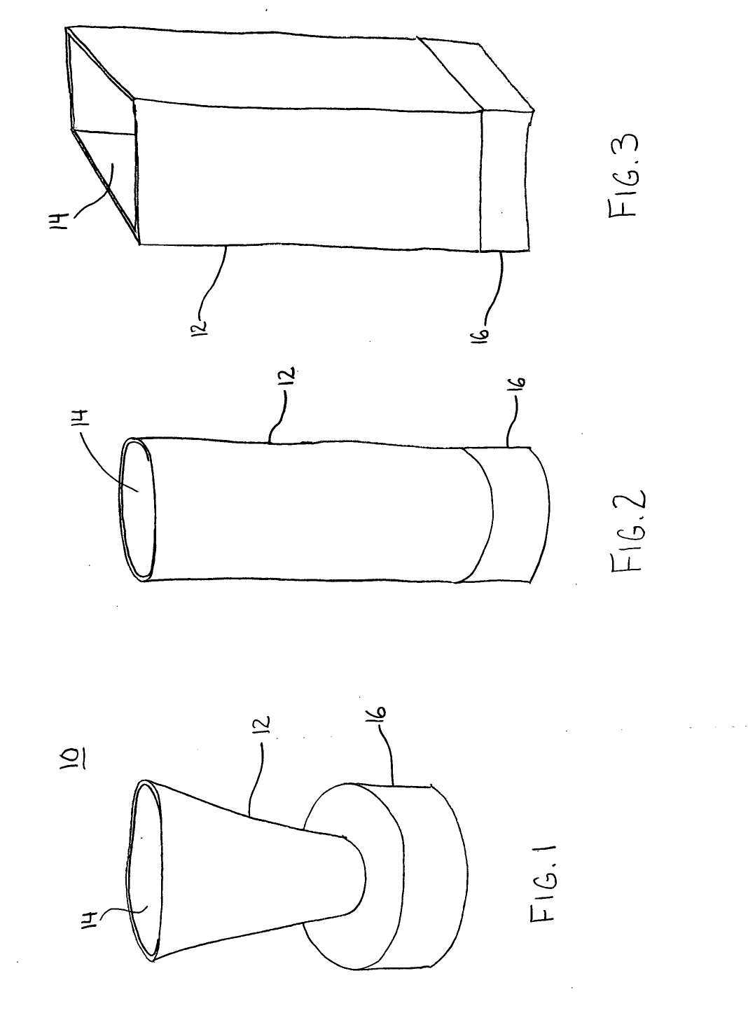

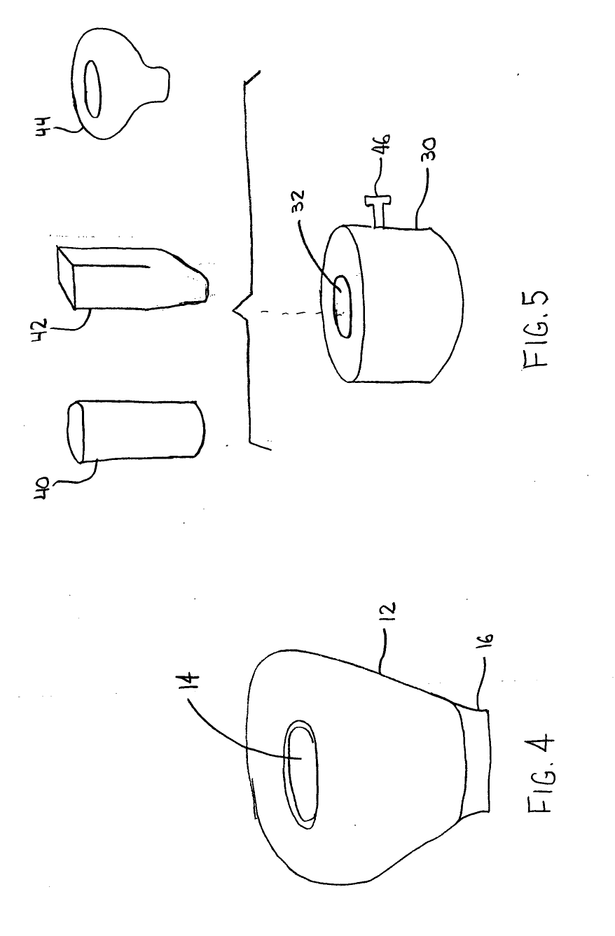

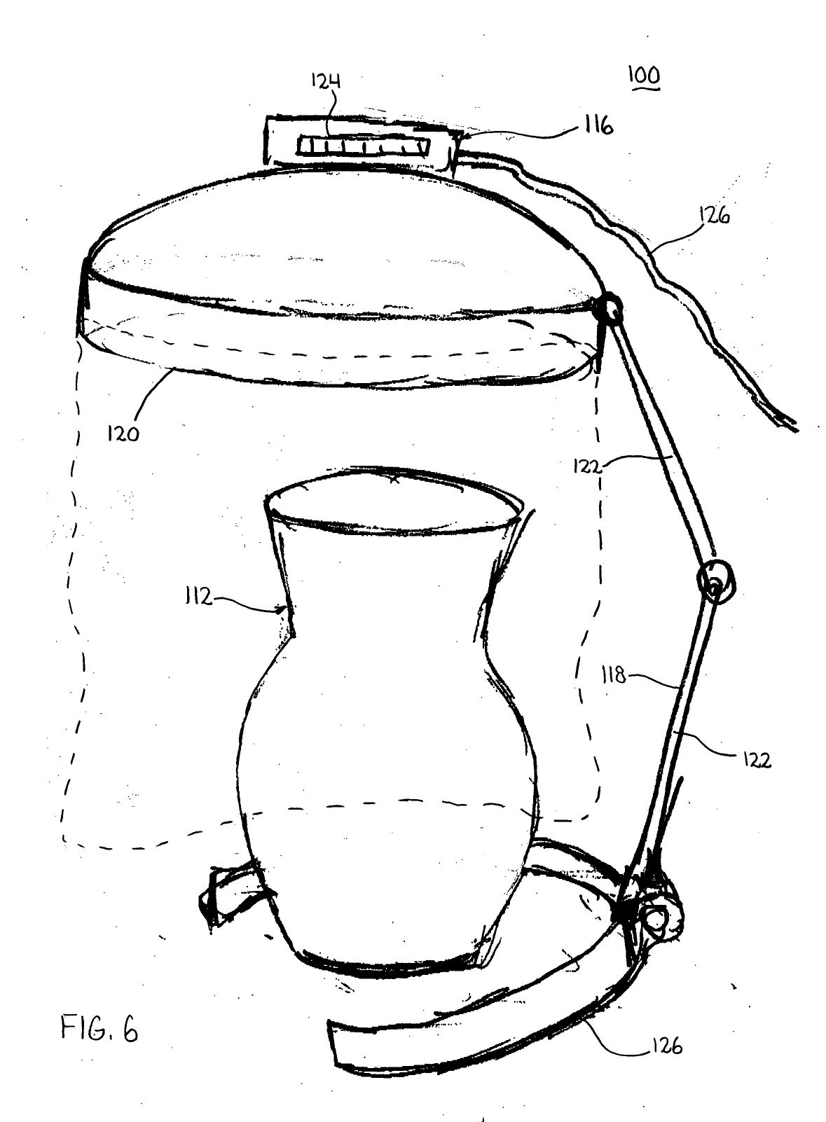

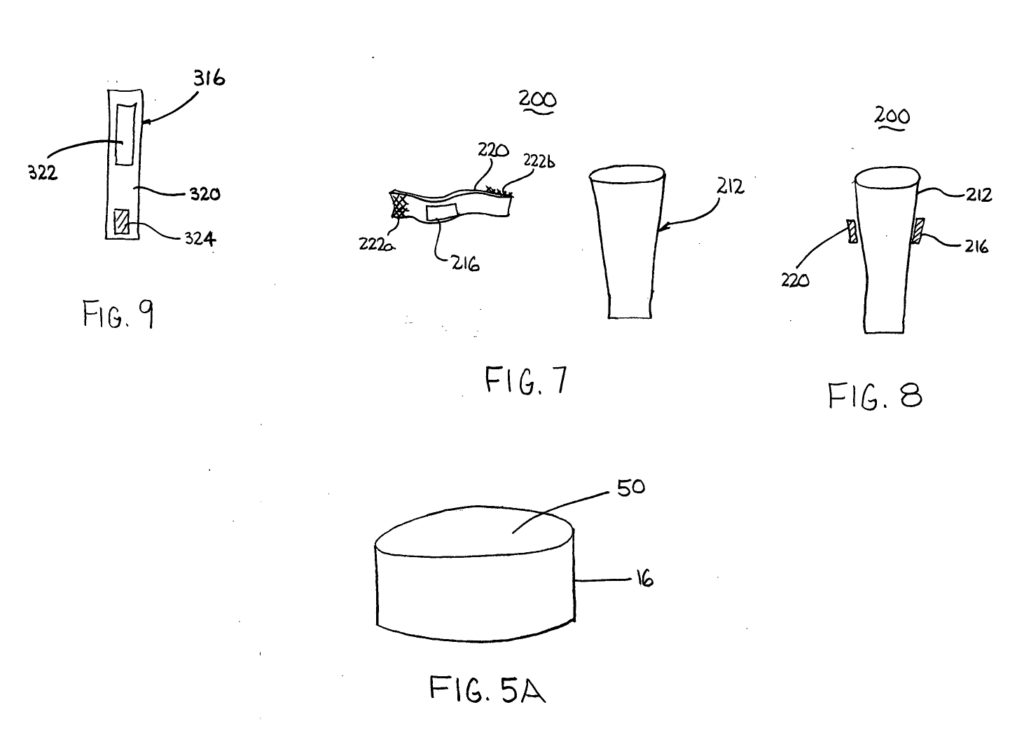

FIG. 1 illustrates one preferred embodiment of the presently disclosed vase and associated cooling device (“chilled vase”) shown generally as 10. Chilled vase 10 includes a body 12 defining an open reservoir 14. Body 10 may be formed from any of a variety of materials including glass, plastic, porcelain and metal. Although illustrated as having a substantially frustoconcial shape, other shapes are envisioned, e.g., cylindrical (FIG. 2), rectangular (FIG. 3), bowl-shaped (FIG. 4), etc. The base of body 12 includes a cooling device 16 which is associated with open reservoir 14. Cooling device 16 includes a cooling element which is preferably a thermal electric cooler, although it is contemplated that other known cooling elements may be used. Depending upon the volume of water to be held or contained within reservoir 14, cooling device 16 may include a fan (not shown). Cooling device 16 is preferably of a capacity to maintain water in reservoir 14 at a temperature from about 35° F. to about 60° F. and preferably from about 40° F. to about 50° F. Preferably, cooling device 16 is electrically powered, e.g., ac/dc power, 12 volt battery etc. A power cord having a plug for receipt in a wall socket (not shown) may be provided to supply power to cooling device 16. An adaptor (not shown) may be provided to limit the power supplied to the cooler.

Cooling device 16 may be integrally formed with body 12 such as by molding. Alternately, it is contemplated that body 12 and cooling device 16 may be releasably attachable together. See FIG. 5. In one-preferred embodiment, cooling device 1-6 includes a base 30 defining a receptacle 32 which is configured to releasably receive vessels, e.g., vessels 40, 42, and 44 of different configurations. See FIG. 5. A locking member, e.g., a set screw 46, may be provided to secure a respective body to cooling device 16. Alternately, cooling device 16 may comprise a flat plate 50 upon which a vessel is positioned. See FIG. 5A.

FIG. 6 illustrates another preferred embodiment of the presently disclosed vase and associated cooling device shown generally as 100. In this embodiment, vase 112 is formed separately from cooling device 116. As discussed above with respect to body 12 of vase 10, vase 112 may be formed from a variety of known materials and assume a variety of configurations. Cooling device 116 includes a stand 118 having a cooling hood 120 supported by stand 118. Stand 118 preferably includes a support base 126 and a plurality of articulatable arms 122 which facilitate positioning of hood 120 in relation to vase 112. Hood 118 preferably includes a thermal electric cooler 124 and a fan (not shown). The fan is positioned to supply cool air to cut flowers (not shown) supported in vase 112. Thermal electric cooler 124 may be battery powered or include a power cord 126 for communication with a wall socket. In one preferred embodiment, a curtain 130 is supported about the periphery of hood 120. Curtain 130 functions to maintain a cooled environment about vase 112 and is preferably clear to permit viewing of flowers within vase 112.

Referring to FIGS. 7 and 8, in another preferred embodiment of the presently disclosed vase and associated cooling device shown generally as 200, cooling device 216 is supported in a wrap around sleeve 220. Sleeve 220 can be-secured about an existing vase 212. Sleeve 220 preferably includes adjustable fastening structure 222a and 222b to facilitate attachment of cooling device 216 to vases having a variety of different sizes and configurations. Alternately, fastening structure can be formed separately from sleeve 220, e.g., a belt, band or strap. The fastening structure 220 may include snaps, buttons and slots, adhesives, etc. Preferably, fastening structure 220 includes hook and loop fasteners.

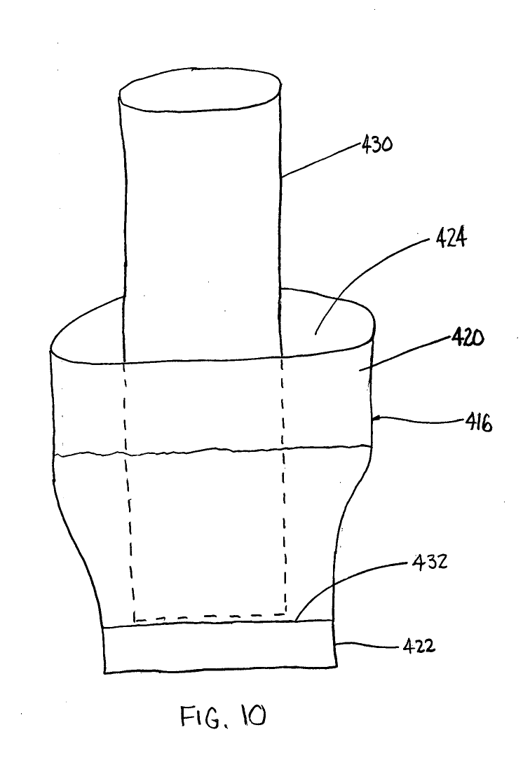

FIG. 9 illustrates another preferred embodiment of the presently disclosed cooling device shown generally as 316. Cooling device 316 includes a body 320 supporting a cooling element 322. Cooling element 322 is preferably a thermal electric cooler although other known cooling elements are contemplated. Body 320 supports cooling element 322. Although body 320 is illustrated as being rectangular, body 320 may assume a variety of configurations, e.g., circular, square, triangular, trapezoidal, etc. Body 320 preferably includes attachment structure 324 for securing body 320 to an existing vessel (not shown). The attachment structure may include adhesives, clips, bands, belts, snaps, magnets, etc. Alternately, it is contemplated that the attachment structure may be formed separately from body 320.

In another preferred embodiment shown in FIG. 10, cooling device 416 includes an oversized vessel 420 defining a reservoir 424 for holding water. A cooling element 422 is supported on device 416 at a position to cool water within reservoir 424. Reservoir 424, although illustrated as being cylindrical, may assume other known configurations. Reservoir 424 is dimensioned and configured to receive and support an existing vessel, e.g., a vase 430. Accordingly, the base 432 of reservoir 424 is preferably flat to support a vessel. In use, water in vessel 420 is cooled to cool the vessel supported therein.

It will be understood that various modifications may be made to the embodiments disclosed herein. For example, although this disclosure focuses primarily on vases for cut flowers, the reservoir cooling device may be used to cool fluid in a variety of different vessels which benefit from reduced temperatures. Therefore, the above description should not be construed as limiting, but merely as exemplifications of preferred embodiments. Those skilled in the art will envision other modifications within the scope and spirit of the claims appended hereto.

1. A vase comprising:
a body defining a fluid reservoir;
a cooling element associated with the body for cooling a fluid located within the reservoir.

2. A vase as recited in claim 1, wherein the cooling element is releasably connected to the body.

3. A vase as recited in claim 1, wherein the body and the cooling element are formed as an integral unit.

4. A vase as recited in claim 1, wherein the cooling element is a thermal electric cooler.

5. A vase as recited in claim 1, wherein the cooling element is of a capacity to maintain water stored in the fluid reservoir at a temperature of from about 35° F. to about 60°.

6. A vase as recited in claim 5, wherein the cooling element is of a capacity to maintain water stored in the fluid reservoir at a temperature of from about 40° F. to about 50° F.

7. A vase as recited in claim 2, wherein the cooling element is supported in a sleeve, the sleeve being releasably attached to the body.

8. A vase is recited in claim 7, wherein the sleeve includes fastening structure for securing the sleeve about the body.

9. A vase as recited in claim 8, wherein the fastening structure is selected from the group consisting of adhesives, clips, ties, belts, straps, snaps, magnets and hook and loop fasteners.

10. A vase as recited in claim 7, wherein the sleeve includes a belt, band or strap.

11. A vase as recited in claim 1, wherein the cooling element is supported within a base defining a support surface for supporting the body.

12. A vase as recited in claim 1, wherein the cooling element is supported within a base defining a receptacle for releasably receiving a portion of the body.

13. A vase as recited in claim 12, further including a locking member for securing the body within the receptacle.

14. A cooling device comprising:
a cooling element;
a sleeve supporting the cooling element; and
adjustable fastening structure associated with the sleeve, the sleeve being formed of a material which can be wrapped about a vessel and secured thereto by the fastening structure.

15. A cooling device according to claim 2, wherein the adjustable fastening structure is supported on the sleeve.

16. A cooling device as recited in claim 14, wherein the cooling element is a thermal electric cooler.

17. A cooling device as recited in claim 14, wherein the fastening structure is selected from adhesives, clips, ties, belts, straps, snaps, magnets, and hook and loop fasteners.

18. A cooling device comprising:
a base housing a cooling element, the base defining a receptacle for releasably engaging a vessel such that the cooling element is in association with the vessel to cool a fluid contained within the vessel.

19. A cooling device as recited in claim 18, further including a locking member for releasably securing a vessel within the receptacle.
